(19) United States
(12) Patent Application Publication
(10) Pub. No.: US 2009/0072622 A1
(43) Pub. Date: Mar. 19, 2009

(54) LOAD DRIVE CIRCUIT, DELAY CIRCUIT, AND SEMICONDUCTOR DEVICE

(75) Inventors: Akihiko GOTO, Ome (JP); Nao Miyamoto, Ome (JP); Shinobu Yabuki, Hamura (JP); Tatsuhiro Aida, Hino (JP)

Correspondence Address: MILES & STOCKBRIDGE PC, 1751 PINNACLE DRIVE, SUITE 500, MCLEAN, VA, 22102-3833, US

(73) Assignee: HITACHI, LTD.

(21) Appl. No.: 12/172,426

(22) Filed: Jul. 14, 2008

(30) Foreign Application Priority Data
Sep. 14, 2007 (JP) 2007-238672
Mar. 14, 2008 (JP) 2008-065084

(51) Int. Cl. H02J 3/14

(52) U.S. Cl. 307/38

(57) ABSTRACT

A level shift 9, IGBT1, 2 and a AND element 10 are provided. An output DOUT is controlled to four states Hi/Lo/HiZ/artificial Hi by controlling input signals IN1, IN2, IN3, PULSE_IN. An element is protected from output short circuiting by transferring an output after a fixed time period to an artificial Hi. Furthermore NMOS are connected in parallel between two inverter circuits and the two stage of the inverter circuit is connected to the gate of NMOS. A delay circuit connecting the output of the initial state of the inverter circuit to a drain and the source of the NMOS to GND is connected to PULSE_IN of the level shift 9. Thus it is possible to almost completely eliminate temperature dependency of the delay time.

### CLAIM OF PRIORITY

The present application claims priority from Japanese patent application JP 2007-238672 filed on Sep. 14, 2007, and JP 2008-065084 filed on Mar. 14, 2008, the contents of which are hereby incorporated by reference into this application.

### FIELD OF THE INVENTION

This invention relates to a load drive circuits supplying a high and a low voltage to a load and to a semiconductor device having one or a plurality of load drive circuits integrated on a single semiconductor substrate. In particular, this invention relates to a semiconductor device and load drive circuit provided with a short-circuit protection circuit preventing failure of a circuit supplying high voltage to a load, such as a scan drive for a plasma display, as a result of short-circuiting between adjacent pins.

Furthermore this invention relates to a delay circuit provided in both the load drive circuit and the semiconductor integrated circuit and used in the above load drive circuit for example in a timing generation circuit or a pulse generation circuit. In particular, the invention relates to a delay circuit compensating for fluctuations over a delay period resulting from thermal fluctuations.

### BACKGROUND OF THE INVENTION

JP-A-2005-284242 discloses short-circuit protection for a scan driver. In particular, FIG. 23 shows an example of a circuit in which an output terminal is set to a high impedance (HiZ level) after a fixed time period, and when the output terminal short circuits, a large current is not applied to the output IGBT.

JP-A-2006-325084 discloses a circuit which, for a short period of time after a drive circuit is switched to an ON position, maintains an output voltage by a stray capacitance.

In particular, FIG. 1 shows a circuit maintaining an output voltage using a stray capacitance.

### SUMMARY OF THE INVENTION

The present inventors examined techniques for short-circuit protection in scan drivers prior to this application. FIG. 23 in JP-A-2005-284242 a circuit using a technique of short-circuit protection for a scan drive.

However this circuit changes an output after a fixed time period from a Hi level to a HiZ level and maintains the Hi level in the output load capacity. As a result, the present inventors realized that after the fixed time period, if there is noise in the output, the output potential can not be maintained to the Hi level since there is not an element to drive the output.

FIG. 1 in JP-A-2006-325084 shows an arrangement of maintaining an output voltage using a stray capacitance in the scan driver circuit.

However the present inventors realized that when an output is short-circuited to a ground potential in this circuit, a potential always exists in the gate emitter of the IGBT and thus short-circuit protection is not enabled.

The present inventors have proposed a load drive circuit as shown in FIG. 1 which provides a technique of short-circuit protection for a scan driver. When specific use conditions are satisfied, this arrangement provides constant short-circuit protection for load drive circuits. However additional investigations performed by the present inventors have shown that when the above specific use conditions are not satisfied, in other words, under use conditions such as temperature fluctuations exceeding fixed ranges, short-circuit protection in a scan driver is not always constantly ensured. This fact is described in further detail hereafter.

A conventional example of a delay circuit 500 is shown in FIG. 5. In other words, the circuit structure is provided with a first inverter circuit having MOS field-effect transistors 1a with a first conductivity type connected in complementary pairs between a positive power supply VDD and a ground potential LGND and MOS field-effect transistors 1b with a second conductivity type, and a second inverter circuit having MOS field-effect transistors 2a with a first conductivity type connected in complementary pairs between a positive power supply VDD and a ground potential LGND and MOS field-effect transistor 2b with a second conductivity type. The output of the first inverter circuit is connected to the input of the second inverter circuit to produce a delay time.

However the delay time of a conventional delay circuit is determined by the characteristics of the individual transistors and the stages in the inverter circuit. Thus fluctuations in the ambient temperature result in large fluctuations in the delay time of individual inverter circuits and as a result large fluctuations in the delay time of the delay circuit after a number of stages.

For example, as shown in FIG. 1, an output can be in a first state (Hi state), a second state (Lo state) having a lower voltage than the first state, a third state (HiZ state) having a higher impedance than the first and second states, and a fourth state (artificial Hi state) having a higher impedance than the first and second states and a lower impedance than the third state. Thus it is possible to use the characteristics of the fourth state (artificial Hi state) in order to protect the circuit from short circuits in the output terminal. However the transition time from a first state (Hi state) to a fourth state (artificial Hi) is determined by a pulse width of PULSE_IN as shown in FIG. 1. Consequently the present inventors realized that since the delay circuit producing PULSE_IN has thermal characteristics, when a fluctuation in the pulse width of PULSE_IN is caused by thermal fluctuations and the transition time from a first state (Hi state) to a fourth state (artificial Hi state) increases as a result of the permissible short-circuit time of the element, there is the possibility that the short-circuit protection circuit will not function properly during the short circuit in the output terminal. “Permissible short-circuit time of an element” is herein defined as the time from the commencement of a saturation current in an element after the short-circuiting of an output terminal of the element to the time when the element no longer functions properly.

A representative example of this invention is described hereafter. In other words, a load drive circuit according to this invention is a load drive circuit supplying a high and a low voltage to a load. The load drive circuit has a first semiconductor switching element, a diode, a second semiconductor switching element, two MOS field-effect transistors having a first conductivity type and two MOS field-effect transistors having a second conductivity type. The first semiconductor switching element is connected between a first power supply and an output terminal. The diode is connected to a cathode via the output terminal and to an anode via the first semiconductor switching element. The second semiconductor switching element is connected between the output terminal and a second power supply supplying a lower potential than the first power supply. The two MOS field-effect transistors having a first conductivity type control the first semiconductor switching element and the two MOS field-effect transistors having a second conductivity type of an opposite conductivity type to the first conductivity type control the first semiconductor switching element. The output terminal is maintained in a first state, a second state having a lower voltage than the first state, a third state having a higher impedance than the first and second states, and a fourth state having a higher impedance than the first and second states and a lower impedance than the third state by the application of a gate drive signal, being a signal applied to the gate terminal of the MOS field-effect transistors having a second conductivity type. The output terminal is maintained in the fourth state for a fixed time period and a voltage equal to the first state is maintained. When the output terminal short circuits, the current flowing between the first power supply and the second power supply is stopped.

A semiconductor device according to this invention has a plurality of load drive circuits provided for a single output bit, the load drive circuits integrated on common semiconductor substrates to form a plurality of output bits and the load drive circuit having the characteristics described above.

A delay circuit according to this invention has a first inverter circuit, a second inverter circuit and a fifth MOS field-effect transistor. The first inverter circuit has a first MOS field-effect transistor having a first conductivity type and inputting an input signal and a second MOS field-effect transistor having a second conductivity type being opposite to the first conductivity type and inputting an input signal. The first MOS field-effect transistor and the second MOS field-effect transistor are connected in complementary pairs between a positive power supply and a ground potential. The second inverter circuit has a third MOS field-effect transistor having a first conductivity type and inputting an output signal of the first inverter circuit and a fourth MOS field-effect transistor having a second conductivity type. The third MOS field-effect transistor and the fourth MOS field-effect transistor are connected in complementary pairs between a positive power supply and a ground potential. The fifth MOS field-effect transistor having a second conductivity type is connected in parallel between the first inverter circuit and the second inverter circuit. The first MOS field-effect transistor and the fifth MOS field-effect transistor have substantially equivalent thermal characteristics.

As described above, a semiconductor device according to this invention has a plurality of load drive circuits provided for a single output bit, the load drive circuits and delay circuits integrated on common semiconductor substrates. The load drive circuit has the characteristics described above. The delay circuit has the characteristics described above.

According to this invention, it is possible to provide a scanning device with short-circuit protection. In particular, even in the event of a fluctuation in the ambient temperature, short-circuit protection of a load drive circuit such as a scan drive is ensured to a greater degree by using a delay circuit having an approximately fixed delay time.

### BRIEF DESCRIPTION OF THE DRAWINGS

FIG. 1 shows an embodiment of a load drive circuit according to this invention;

FIG. 2 shows an example of a switching sequence in a load drive circuit shown in FIG. 1;

FIG. 3 shows an example of a chip mounting a load drive circuit as shown in FIG. 1;

FIG. 4 shows the overall structure of a plasma display adapting a load drive circuit according to this invention as a scan driver;

FIG. 5 shows a conventional delay circuit;

FIG. 6 shows a temperature characteristics compensation delay circuit as an example of a delay circuit according to this invention;

FIG. 7 shows an example of a switching sequence in a delay circuit as shown in FIG. 6;

FIG. 8 shows a semiconductor integrated circuit as an embodiment of a semiconductor device according to this invention; and

FIG. 9 shows a relationship between the pulse width PULSE_IN and the permissible short-circuit time of an element (IGBT).

### DETAILED DESCRIPTION OF THE PREFERRED EMBODIMENTS

The delay circuit of this invention has a MOS field-effect transistor and two inverter circuits. The MOS field-effect transistor having a first conductivity type is connected between a positive power supply and a ground potential and receives an input signal or an output signal from an inverter circuit in a previous stage. The two inverter circuits have MOS field-effect transistors having a second conductivity type opposite to the first conductivity type connected in complementary pairs thereto. Furthermore a MOS field-effect transistor having a second conductivity type opposite to the first conductivity type is connected in parallel between the two inverter circuits.

This arrangement allows normal operation of short-circuit protection functions in a load drive circuit according to this invention irrespective of the ambient temperature. Thus even in the event of fluctuation in the ambient temperature, the delay time of the delay circuit is approximately fixed.

A load drive circuit according to this invention is a load drive circuit which supplies a high and a low voltage to a load and is provided with a first semiconductor switching element connected between a first power supply and an output terminal, a diode being connected to a cathode via the output terminal and to an anode via the first semiconductor switching element, a second semiconductor switching element connected between the output terminal and a second power supply supplying a lower potential than the first power supply, two MOS field-effect transistors having a first conductivity type controlling the first semiconductor switching element, two MOS field-effect transistors having a second conductivity type of an opposite type to the first conductivity type controlling the first semiconductor switching element. The output terminal is maintained in a first state, a second state having a lower voltage than the first state, a third state having a higher impedance than the first and second states, and a fourth state having a higher impedance than the first and second states and a lower impedance than the third state by the application of a gate drive signal, being a signal applied to the gate terminal of the MOS field-effect transistors having a second conductivity type. The output terminal being maintained in the fourth state for a fixed time period, a voltage equal to the first state being maintained and when the output terminal short circuits, the current flowing between the first power supply and the second power supply is stopped.

This arrangement enables short-circuit protection for a load drive circuit. In particular, it is possible to ensure short-circuit protection in a load drive circuit more accurately by using a delay circuit on the input side, that is to say, a delay circuit having an approximately fixed delay time in the delay circuit even during fluctuations in ambient temperatures in order to normal operation of short-circuit protection in a load drive circuit irrespective of ambient temperatures.

Furthermore a semiconductor device according to this invention has a number of load drive circuits equal to the number of output bits provided with respect to a plurality of output bits. The load drive circuits are integrated on common semiconductor substrates. In another embodiment, a plurality of load drive circuits and the above delay circuits are integrated on common semiconductor substrates.

Thus the invention provides a delay circuit having an approximately fixed delay time irrespective of fluctuations in the ambient temperature. Therefore use of the delay circuit provides a load drive circuit such as a scan drive with a short-circuit protection function which operates normally even in the event of fluctuation in the ambient temperature.

The embodiments of this invention will be described in further detail hereafter making reference to the drawings.

### First Embodiment

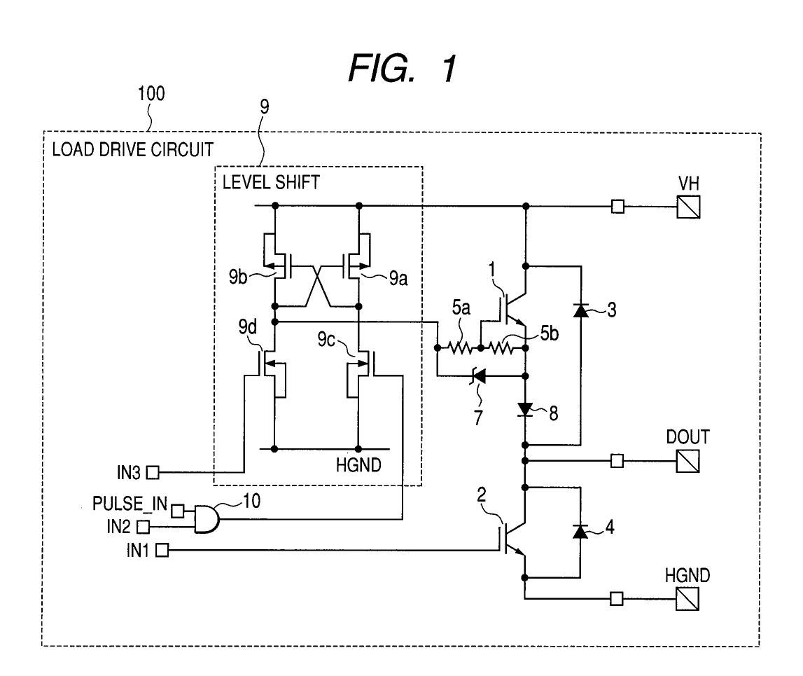

FIG. 1 shows a first embodiment of a load drive circuit according to this invention. In FIG. 1, a load drive circuit 100 has semiconductor switching elements 1, 2, diodes 3, 4, 8, resistance elements 5a, 5b connected in series, a Zener diode 7 connected in parallel with the resistance elements 5a, 5b, a level shift circuit 9, and a NAND element 10. The level shift circuit 9 has MOS field-effect transistors 9a, 9b having a first conductivity type (PMOS) and MOS field-effect transistors 9c, 9d having a second conductivity type (NMOS). The first conductivity type and the second conductivity type have mutually opposite polarity. In the example shown in FIG. 1, the first conductivity type has a P-type conductivity and the second conductivity type has N-type conductivity. The semiconductor switching elements 1, 2 are preferably an insulated gate bipolar transistor (IGBT). The gate of the IGBT 1 is connected to the connection point of the resistance elements 5a and 5b. A signal input terminal IN1 is connected to the gate of the IGBT 2. The output of an AND logic gate 10 connected by the input to a signal input terminal IN2 and a pulse input terminal PULSE_IN is connected to the gate of the NMOS 9c. A signal input terminal IN3 is connected to the gate of the NMOS 9d. The first semiconductor switching element 1 constituted by an IGBT is connected between a first power supply VH and the output terminal DOUT. Similarly the second semiconductor switching element 2 constituted by an IGBT is connected between a second power supply HGND and the output terminal DOUT. The first power supply VH and the second power supply HGND are preferably power supplies which supply a high potential and a ground potential. An anode connected to the first semiconductor switching element and a diode 8 connected to the second semiconductor switching element via a cathode are provided between the first and the second semiconductor switching elements. The cathode of the diode 8 and the collector of the IGBT 1 are interconnected through the diode 3. An emitter and the collector of the IGBT 2 are interconnected through the diode 4. MOS field-effect transistors 9a, 9b having a first conductivity type (PMOS) and MOS field-effect transistors 9c, 9d having a second conductivity type (NMOS) are interconnected by a drain. The source of PMOS 9a, 9b is connected to a first power supply and the source of NMOS 9c, 9d is connected to a second power supply. The drain of PMOS 9a is connected to the gate of PMOS 9b and the drain of PMOS 9b is connected to the gate of PMOS 9a in the form of a so-called cross couple structure. The common drain for PMOS 9b and PMOS 9d is connected to one end on the side opposite to the side having the connection of the resistance 5a and the resistance 5b.

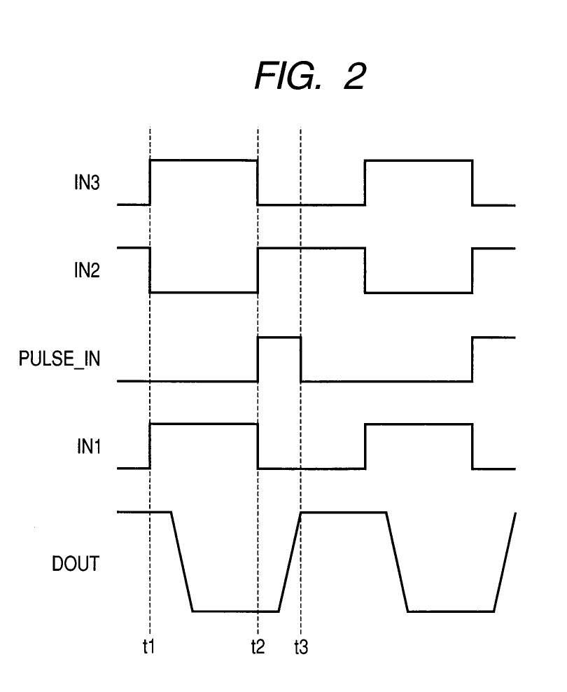

FIG. 2 shows an output potential switching sequence of the load drive circuit shown in FIG. 1.

At a time t1, IN1 is placed at a Hi position and IGBT2 is placed in the ON position, IN2 is at a Lo position and IN3 is in the Hi position. Consequently IGBT1 is in the OFF position. At this time, the output DOUT is a Lo output.

At a time t2, NMOS 9c is ON and NMOS 9d is OFF since IN1 is at a Lo position and IGBT2 is in the OFF position, IN2 is at a Hi position and IN3 is in the Lo position, and PULSE_IN is synchronized with IN2 to a Hi position. Since NMOS 9c is ON, NMOS 9d is ON. Therefore a current flows through the diode 8 and the resistance elements 5a, 5b from PMOS 9b to the output DOUT. The electric potential difference produced by the resistance element 5b at this time takes the form of a positive bias on the gate emitter of IGBT1, and IGBT1 is placed in the ON position. A Zener diode 7 is provided to limit the potential between the gate emitters of IGBT1 in order to protect the IGBT gate. At this time, the output DOUT has an Hi output.

At a time t3, NMOS 9c is OFF since PULSE_IN is Lo. The level shift 9 is in a latching state, and even when the output. DOUT has a slightly reduced potential as a result of noise for example, PMOS 9b is retained slightly to an ON position. Since PMOS 9b is slightly in an ON position, a slight current flows to the output DOUT through the diode 8 and the resistance elements 5a, 5b from the PMOS 9b. This slight current is sufficient to maintain IGBT1 in an ON position and the output DOUT in a Hi state. As a result, even when the potential of the output DOUT decreases as a result of noise for example, the output DOUT can be forcibly returned to a Hi state and maintained in such a state. From the foregoing, an artificial Hi state is defined as a state in which a current which is smaller than a normal Hi output is applied and the output terminal is artificially maintained in a Hi state. In the example shown in FIG. 1, the latch characteristics of the level shift 9 are used to produce an artificial Hi state having a smaller current than normal. However this invention is not dependent on the manner of producing a current which is smaller than normal and thus is not limited to the example shown in FIG. 1.

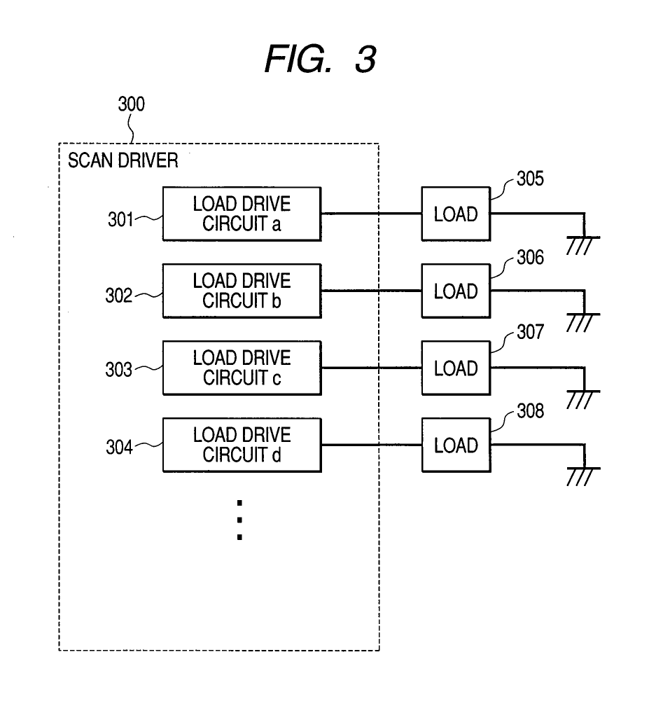

As shown in FIG. 3, a scan driver is formed by a plurality of the load drive circuits as shown in FIG. 1. The individual load drive circuits a-d (301-304) drive respectively separate loads 305-308 and respectively form a set of output bits. If as a result of some type of accident, an output DOUT becomes short-circuited with another output DOUT, another bit will cause the output DOUT to have a Lo potential and a saturation current will flow to IGBT1. However at this time since the output DOUT is at a Lo potential, the gate potential of PMOS 9a is Lo and PMOS 9a is placed in an ON position. Since PULSE_IN is maintained in a Lo position, NMOS 9c is OFF. Consequently PMOS 9b is OFF, a current no longer flows to the resistance elements 5a, 5b. The potential between the gate emitters of IGBT1 is lost, IGBT1 is placed in an OFF position and the current in IGBT1 is stopped.

The time interval between t3 and t2 takes a value which is greater than or equal a time sufficient to drive the output DOUT to a Hi position when there is not an output short circuit. When there is a short circuit, it is the time when the IGBT will not fail even when a saturation current flows in the IGBT 1.

In addition to the three states described above, in the example of a load drive circuit shown in FIG. 1, it is possible to set both IGBT1 and 2 to an OFF position by setting IN1 to Lo, IN2 to Lo and IN3 to Hi and thus place the output DOUT is in a HiZ state. When the output DOUT is in an HiZ state, the DOUT potential can be freely set by another driver connected to DOUT. The relationship between the artificial Hi state and the HiZ state is as follows. An artificial Hi state has a lower impedance than a HiZ state and a slight current flows in the resistance elements 5a, 5b. However when the impedance is higher than a Hi state, the current flowing to the resistance elements 5a, 5b is less than that flowing during a Hi state.

### Second Embodiment

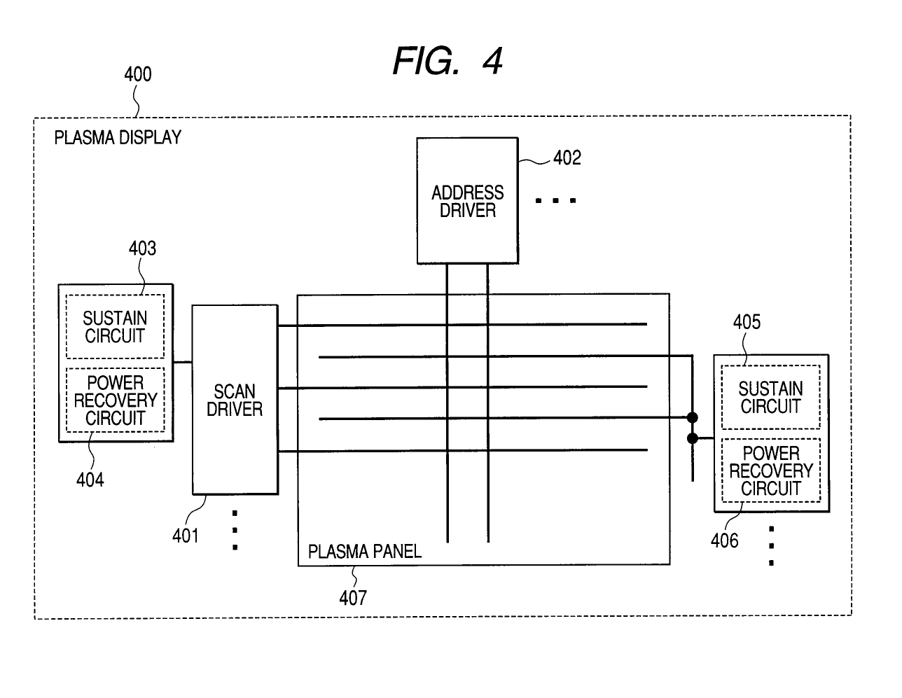

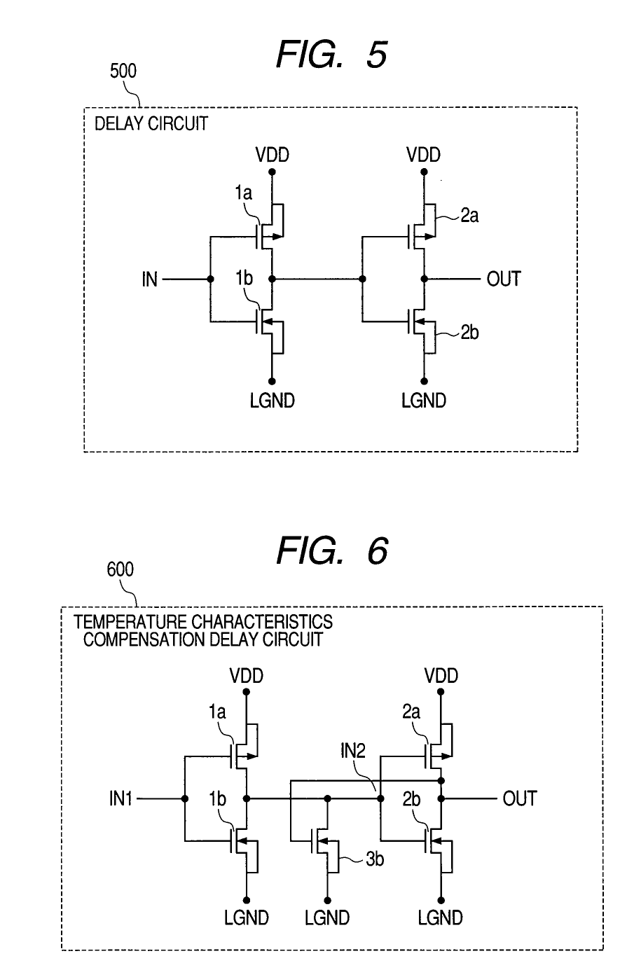

FIG. 4 shows an embodiment of a plasma display wherein the scan driver is a load drive circuit according to this invention or a semiconductor device mounting and integrating the load drive circuit on a common semiconductor substrate. In FIG. 4, a plasma display 400 has a scan driver 401, an address driver 402, sustain circuits 403, 405, and power recovery circuits 404, 406. The scan driver 401 is connected to a scanning line running longitudinally on the plasma panel 407. The address driver 402 is connected to a data line running in a vertical direction of the plasma panel 407. The sustain circuit 405 is connected to a sustain line running longitudinally on the plasma panel 407.

The illumination period of the plasma panel 407 is divided into a scan period and a sustain period. During the scan period, the scan driver 401 falls from a Hi potential to a Lo potential on consecutive scanning lines. At this time, no two scanning lines fall to a Lo position at the same time and only one scanning line falls to the Lo position. The address driver 402 supplies color information to the data line at positions on the plasma panel 407 falling to a Lo potential as a result of the scan driver 401. The points of intersection of data lines supplied with color information by the address driver 402 and scanning lines falling to a Lo potential due to the scan driver 401 are illuminated by preliminary discharge. After preliminary discharge is completed at all positions on the plasma panel 407, the illumination period of the plasma panel 407 shifts to the sustain period. During the sustain period, illumination resulting from preliminary discharge performed during the scan period is continued and an image is displayed on the plasma panel 407.

During the scan period, only one of the plural output bits in the scan driver 401 is always in a Lo state and the other bits are in a Hi state. At this time, when one output bit short circuits with an adjacent bit, a short circuit between a Hi state and a Lo state occurs. Generally since a high voltage is used to drive the plasma panel 407, failure of the scan driver may result from the generation of a short circuit. Furthermore there is no certainty that the plasma panel will not fail depending on how it is used. Use of a load drive circuit according to this invention which provides a short circuit protection function to the scan driver will prevent failure of the scan driver and the plasma panel.

### Third Embodiment

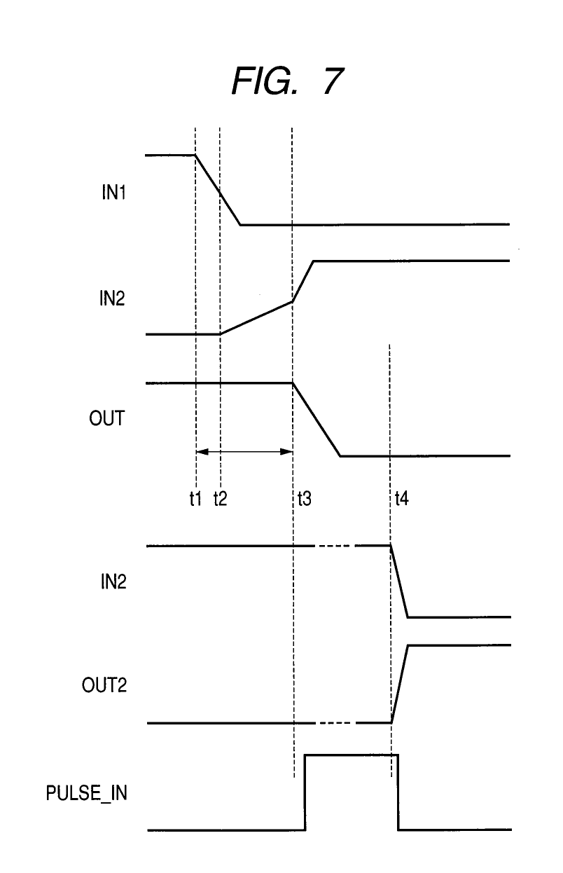

FIG. 6 shows an embodiment of a delay circuit according to this invention and shows a delay circuit for correcting temperature characteristics. In FIG. 6, the delay circuit is provided with a MOS field-effect transistor (NMOS) 3b having a second conductivity type connected in parallel between two inverters provided with MOS field-effect transistors 1a, 2a (PMOS) having a first conductivity type and MOS field-effect transistors 1b, 2b (NMOS) having a second conductivity type.

The first conductivity type and the second conductivity type have mutually opposite polarity. In the example shown in FIG. 6, the first conductivity type has a P-type conductivity and the second conductivity type has N-type conductivity. However this arrangement is the first embodiment and the invention is not limited in this regard. For example, the first conductivity may be an N-type and the second conductivity may be a P-type.

An input signal IN1 is connected to the gate of PMOS1a, NMOS1b. The output of an initial inverter constituted by PMOS1a and NMOS1b is connected to the gates of PMOS2a, NMOS2b. The output of a second stage inverter constituted by PMOS2a and NMOS2b is connected to the gate of NMOS3b.

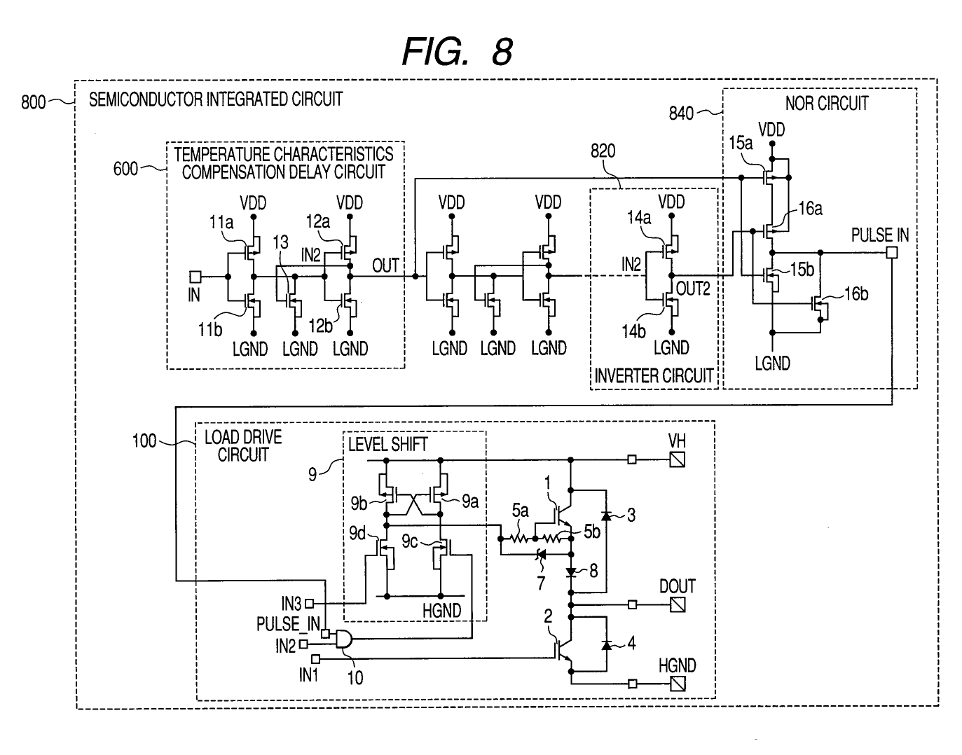

FIG. 7 shows the switching sequence of the output potential of the delay circuit shown in FIG. 6. When IN1 is in the Hi position up to a time t1, NMOS1b is OFF, PMOS2a is ON and IN2 is Low. When IN2 is in the Low position up to a time t1, NMOS2b is OFF, PMOS2a is ON and OUT is Hi. At this time, since OUT is connected to the gate of NMOS3b, NMOS3b is ON.

When IN1 is initially in a Low position at a time t1, PMOS1a is ON and NMOS1b is OFF. When PMOS1a changes to the ON position, a current flows from PMOS1a to IN2. Since NMOS3b is ON at this time, the current flowing from PMOS1a is drawn to LGND through NMOS3b in addition to flowing to IN2. In other words, the voltage of IN2 gradually increases.

Since NMOS3b is ON at a time t2, the voltage in IN2 gradually increases. However when the voltage of IN2 is greater than or equal to a fixed value at a time t3, since NMOS2b is ON and PMOS2a is OFF, OUT changes to a Low position and NMOS3b changes to OFF.

When NMOS3b is OFF at a time t3, the current flowing from PMOS1a is no longer drawn to LGND and the voltage in IN2 sharply increases.

The delay time is the time difference taken by an input voltage and an output voltage to respectively reach a certain voltage. The majority of the time difference of this delay circuit is determined by the interval t3 and t2 in FIG. 7.

In the interval t3 and t2, when the ambient temperature is low, the current flowing from PMOS1a increases due to the decrease in the ON resistance value of PMOS1a. However, the current drawn to LGND via NMOS3b increases as a result of the decrease in the ON resistance value of NMOS3b. In other words, the decrease in the ON resistance value of PMOS1a and the decrease in the ON resistance value of NMOS3b cancel out and the delay time is the same as that at room temperature.

When the ambient temperature is high, the increase in the ON resistance value of PMOS1a cancels out with the increase in the ON resistance value of NMOS3b and the delay time is the same as that at room temperature.

As shown above, according to the present embodiment, it is possible to obtain an approximately fixed delay time even during fluctuation in the ambient temperature by connecting NMOS in parallel between the inverter circuit constituted by PMOS and NMOS which are connected in complementary pairs between the positive power supply and the ground potential. Alternatively the use of the delay circuit provides a load drive circuit having a short circuit protection function which operates during output short circuits and even during fluctuation in the ambient temperature.

### Fourth Embodiment

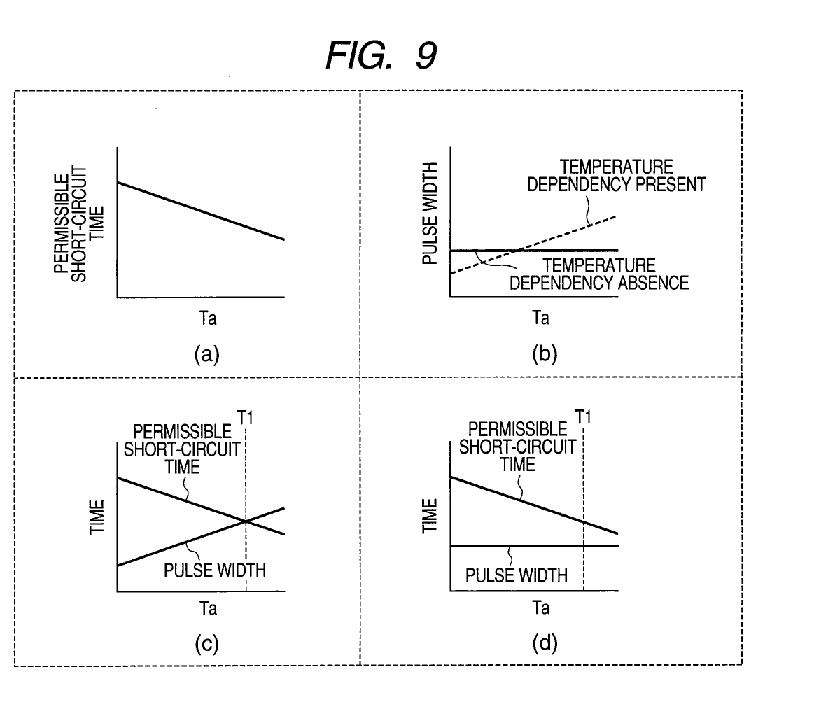

FIG. 8 shows a semiconductor integrated circuit 800 which is an embodiment of a semiconductor device in which the delay circuit and the load drive circuit of this invention are integrated on a common semiconductor substrate.

A load drive circuit 100 has semiconductor switching elements 1, 2, diodes 3, 4, 8, resistance elements 5a, 5b connected in series, a Zener diode 7 connected in parallel with the resistance elements 5a, 5b, a level shift circuit 9, and a NAND element 10. The level shift circuit 9 has MOS field-effect transistors 9a, 9b having a first conductivity type (PMOS) and MOS field-effect transistors 9c, 9d having a second conductivity type (NMOS). The first conductivity type and the second conductivity type have mutually opposite polarity. In the example shown in FIG. 8, the first conductivity type has a P-type conductivity and the second conductivity type has N-type conductivity. The semiconductor switching elements 1, 2 are preferably an insulated gate bipolar transistor (IGBT). The gate of the IGBT 1 is connected to the connection point of the resistance elements 5a and 5b. A signal input terminal IN1 is connected to the gate of the IGBT 2. The output of an AND logic gate 10 connected by the input to a signal input terminal IN2 and a pulse input terminal PULSE_IN is connected to the gate of the NMOS9c. A signal input terminal IN3 is connected to the gate of the NMOS9d. The first semiconductor switching element 1 constituted by an IGBT is connected between a first power supply VH and the output terminal DOUT. Similarly the second semiconductor switching element 2 constituted by an IGBT is connected between a second power supply HGND and the output terminal DOUT. The first power supply VH and the second power supply HGND are preferably power supplies which supply a high potential and a ground potential. An anode connected to the first semiconductor switching element and a diode 8 connected to the second semiconductor switching element via a cathode are provided between the first and the second semiconductor switching elements. The cathode of the diode 8 and the collector of the IGBT are interconnected through the diode 3. An emitter and the collector of the IGBT 2 are interconnected through the diode 4. MOS field-effect transistors 9a, 9b having a first conductivity type (PMOS) and MOS field-effect transistors 9c, 9d having a second conductivity type (NMOS) are interconnected by a drain. The source of PMOS 9a, 9b is connected to a first power supply and the source of NMOS 9c, 9d is connected to a second power supply. The drain of PMOS 9a is connected to the gate of PMOS 9b and the drain of PMOS 9b is connected to the gate of PMOS 9a in the form of a so-called cross couple structure. The common drain for PMOS 9b and PMOS 9d is connected to one end on the side opposite to the side having the connection of the resistance 5a and the resistance 5b.

The output potential switching sequence of the load drive circuit 100 shown in FIG. 8 is shown in FIG. 2 in the same as the load drive circuit shown in FIG. 1.

At a time t1, IN1 is Hi and IGBT2 is ON, IN2 is Lo and IN3 is Hi. Consequently IGBT1 is in the OFF position. At this time, the output DOUT is a Lo output.

At a time t2, NMOS 9c is ON and NMOS 9d is OFF since IN1 is Lo and IGBT2 is in the OFF position, IN2 is Hi and IN3 is Lo, and PULSE_IN is synchronized with IN2 to a Hi position. Since NMOS 9c is ON, NMOS 9d is ON. Therefore a current flows through the diode 8 and the resistance elements 5a, 5b from PMOS 9b to the output DOUT. The electric potential difference produced by the resistance element 5b at this time takes the form of a positive bias on the gate emitter of IGBT1, and IGBT1 is placed in the ON position. A Zener diode 7 is provided to limit the potential between the gate emitters of IGBT1 in order to protect the IGBT gate. At this time, the output DOUT has a Hi output.

At a time t3, NMOS 9c is OFF since PULSE_IN is Lo. The level shift 9 is in a latching state, and even when the output DOUT has a slightly reduced potential as a result of noise for example, PMOS 9b is retained slightly to an ON position. Since PMOS 9b is slightly in an ON position, a slight current flows to the output DOUT through the diode 8 and the resistance elements 5a, 5b from the PMOS 9b. This slight current is sufficient to maintain IGBT1 in an ON position and the output DOUT in a Hi state. As a result, even when the potential of the output DOUT decreases as a result of noise for example, the output DOUT can be forcibly returned to a Hi state and maintained in such a state. From the foregoing, an artificial Hi state is defined as a state in which a current which is smaller than a normal Hi output is applied and the output terminal is artificially maintained in a Hi state.

The point of difference between the load drive circuit in FIG. 1 and that shown in FIG. 8 is that the load drive circuit 100 in FIG. 1 is integrated on a common semiconductor substrate together with a temperature characteristics compensation delay circuit 600. As shown in FIG. 8, an inverter circuit 820 and a NOR circuit 840 may also be integrated on the same common semiconductor substrate. In the example shown in FIG. 8, the output of multiple series connections of the temperature characteristics compensation delay circuit 600 is connected to the input of the inverter circuit 820. The output of the initial stage of the temperature characteristics compensation delay circuit 600 and the output of the inverter circuit 820 are connected to the input of the NOR circuit 840. The output terminal PULSE_IN of the NOR circuit 840 is connected with the input terminal PULSE_IN of the load drive circuit 100.

The scan driver 300 as shown in FIG. 3 is constituted by a plurality of aligned load drive circuits 100 as shown in FIG. 8. In other words, the previous stage circuit constitutes a plurality of temperature characteristics compensation delay circuits 600 connected in series, inverter circuits 820 and NOR circuits 840. The previous state circuits are connected individually to the respective inputs of the load drive circuits a-d (301-304). The individual load drive circuits a-d (301-304) drive respectively separate loads 305-308 and respectively form an output bit. If as a result of some type of accident, an output DOUT becomes short-circuited with another output DOUT, another bit will cause the output DOUT to have a Lo potential and a saturation current will flow to IGBT1. However at this time since the output DOUT is at a Lo potential, the gate potential of PMOS 9a is Lo and PMOS 9a is placed in an ON position. Since PULSE_IN is maintained in a Lo position, NMOS 9c is OFF. Consequently PMOS 9b is OFF and current no longer flows to the resistance elements 5a, 5b. The potential between the gate emitters of IGBT1 is lost, IGBT1 is placed in an OFF position and the current in IGBT1 is stopped.

As described above, when an output DOUT short circuits with another output DOUT, the output DOUT is changed to a Lo potential by another bit and a saturation current flows to IGBT1. The time period from the time that the output DOUT short circuits with another output DOUT and saturation current starts to flow in IGBT1, saturation current continues to flow to IGBT1 until the time that IGBT1 no longer functions properly is called the permissible short-circuit time.

FIG. 9 shows the relationship of the permissible short-circuit time of IGBT1 to the pulse length PULSE_IN wherein (a) shows ambient temperature Ta on the horizontal axis and the permissible short-circuit time of IGBT1 on the vertical axis. When the temperature increases, a decrease in permissible short-circuit time depends on the characteristics of the device. In (b), ambient temperature Ta is shown on the horizontal axis and the pulse width PULSE_IN is shown on the vertical axis. Pulse width displaying temperature dependency and pulse width displaying almost no temperature dependency are shown in the figure. (c) shows ambient temperature Ta on the horizontal axis and time on the vertical axis and shows a correlation between permissible short-circuit time and temperature-dependent pulse width. (d) shows a relationship between permissible short-circuit time and pulse width displaying almost not temperature dependency.

In (c) of FIG. 9, until a temperature T1 in the figure, the pulse width driving IGBT1 is smaller than the permissible short-circuit time. In other words, since the time corresponding to the pulse width is short, during output short circuiting, the short circuit protection circuit operates normally to protect IGBT1. However at temperatures greater than or equal to T1, the time corresponding to the pulse width driving IGBT1 is greater than or equal to the permissible short-circuit time. Thus during output short circuiting, there is the possibility that short circuit protection circuit will not operate properly to give sufficient protection to IGBT1.

In contrast, when a temperature characteristics compensation delay circuit 600 as shown in this embodiment is used, the relationship between the permissible short-circuit time of IGBT1 and the pulse width is as shown in (d) of FIG. 9. In comparison to the state shown in (c) of FIG. 9, the temperature dependency of the pulse width is suppressed to a small value. In this manner, even above a certain temperature T1, the pulse width driving IGBT1 is smaller than the permissible short-circuit time, that it to say, it is possible to maintain a state in which the time corresponding to a pulse width is shorter than the permissible short-circuit time. As a result, even at temperature greater than T1, the short circuit protection circuit will operate normally during output short circuits and IGBT1 will be protected.

The interval t2 and t3 takes a value which is greater than or equal a time sufficient to drive the output DOUT to a Hi position when there is not an output short circuit. When there is a short circuit, it is the time when IGBT will not fail even when a saturation current flows in the IGBT1.

In addition to the three states described above, in the example of a load drive circuit, it is possible to set both IGBT1 and 2 to an OFF position by setting IN1 to Lo, IN2 to Lo and IN3 to Hi and it is possible to place the output DOUT in a HiZ state. When the output DOUT is in a HiZ state, the DOUT potential can be freely set by another driver connected to DOUT.

The load drive circuit 100 shown in FIG. 1 can be in a first state (Hi state), a second state (Lo state) having a lower voltage than the first state, a third state (HiZ state) having a higher impedance than the first and second states, and a fourth state (artificial Hi state) having a higher impedance than the first and second states and a lower impedance than the third state. Thus it is possible to use the characteristics of the fourth state (artificial Hi state) in order to protect the circuit from short circuits in the output terminal. However the transition time from a first state (Hi state) to a fourth state (artificial Hi) is determined by a pulse width of PULSE_IN as shown in FIG. 1. Consequently the present inventors realized that since the delay circuit producing PULSE_IN has thermal characteristics, when a fluctuation in the pulse width of PULSE_IN is caused by thermal fluctuations and the transition time from a first state (Hi state) to a fourth state (artificial Hi state) increases as a result of the permissible short-circuit time of the element, there is the possibility that the short-circuit protection circuit will not function properly during the short circuit in the output terminal.

However, the load drive circuit 100 shown in FIG. 8 has an approximately fixed time PULSE_IN which is not dependent on fluctuations in the ambient temperature.

The time for PULSE_IN as shown in FIG. 8 is produced by the temperature characteristics compensation delay circuit 600, the inverter circuit 820 and the NOR circuit 840 which are multiple stages connected in series.

The temperature characteristics compensation delay circuit 600 in each stage is provided with a MOS field-effect transistor (NMOS) 3b having a second conductivity type connected in parallel between two inverters provided with MOS field-effect transistors 1a, 2a (PMOS) having a first conductivity type and MOS field-effect transistors 1b, 2b (NMOS) having a second conductivity type.

The first conductivity type and the second conductivity type have mutually opposite polarity. In the example shown in FIG. 8, the first conductivity type has a P-type conductivity and the second conductivity type has N-type conductivity. However this arrangement is the same as the third embodiment as shown in FIG. 6 and the invention is not limited in this regard.

An input signal IN1 is connected to the gate of PMOS1a, NMOS1b. The output of an initial inverter constituted by PMOS1a and NMOS1b is connected to the gates of PMOS2a, NMOS2b. The output of a second stage inverter constituted by PMOS2a and NMOS2b is connected to the gate of NMOS3b.

The output potential switching sequence of the temperature characteristics compensation delay circuit 600 shown in FIG. 8 is shown in FIG. 2 and is the same as the temperature characteristics compensation delay circuit 600 shown in FIG. 6.

The majority of the delay time is determined by the interval t3 and t2. When the ambient temperature is low in the interval t3 and t2, the decrease in the ON resistance value of PMOS1 cancels out with the decrease in the ON resistance value of NMOS3b and there is no difference with the delay time at room temperature. In the same manner, when the ambient temperature is high, the increase in the ON resistance value of PMOS1 cancels out with the increase in the ON resistance value of NMOS3b and there is no difference with the delay time at room temperature. Thus a delay circuit according to this invention can approximately fix the delay time even during fluctuations in the ambient temperature.

The pulse width of PULSE_IN which determines the transition time from a first state (Hi state) to a fourth state (artificial Hi state) is produced by the temperature characteristics compensation delay circuit 600 above, the inverter circuit 820 shown in FIG. 8 and the NOR circuit 840. The pulse width PULSE_IN is determined by the NOR circuit 840 inputting the temperature OUT2 and the output OUT as shown in FIG. 8. Thus when the terminal OUT and the terminal OUT2 are low, this value becomes the width of PULSE_IN.

According to this embodiment, the period when the terminal OUT and the terminal OUT2 are low is the interval t3 and t4 as shown in FIG. 7. Since this period is almost completely determined by the delay period of the temperature characteristics compensation delay circuit 600, the production of an approximately fixed pulse signal is possible irrespective of fluctuations in the ambient temperature. Furthermore it is possible to ensure short circuit protection for a semiconductor device (semiconductor integrated circuit), on which load drive circuits such as scan drivers are integrated, without reference to fluctuations in the ambient temperature.

According to the embodiments of this invention, the output can be in a first state (Hi state), a second state (Lo state) having a lower voltage than the first state, a third state (HiZ state) having a higher impedance than the first and second states, and a fourth state (artificial Hi state) having a higher impedance than the first and second states and a lower impedance than the third state. Thus it is possible to use the characteristics of the fourth state (artificial Hi state) in order to protect the circuit from short circuits in the output terminal. Furthermore it is possible to use the characteristics of the third state (HiZ state) to freely set the potential of the output terminal. Thus it is possible to provide a load drive circuit having a short circuit protection function and which can be applied to a scan driver.

What is claimed is:

1. A load drive circuit for supplying a high and a low voltage to a load, the load drive circuit comprising:
a first semiconductor switching element being connected between a first power supply and an output terminal;
a diode being connected to a cathode via the output terminal and to an anode via the first semiconductor switching element;
a second semiconductor switching element being connected between the output terminal and a second power supply being to supply a lower potential than the first power supply;
a first couple of MOS field-effect transistors having a first conductivity type, the first couple of MOS field-effect transistors being to control the first semiconductor switching element; and
a second couple of MOS field-effect transistors having a second conductivity type being opposite to the first conductivity type, the second couple of MOS field-effect transistors being to control the first semiconductor switching element,
wherein the output terminal is maintained in a state by the application of a gate drive signal, being a signal applied to the gate terminal of the second couple of MOS field-effect transistors, the state being a first state, a second state having a lower voltage than the first state, a third state having a higher impedance than the first and second states, and a fourth state having a higher impedance than the first and second states and a lower impedance than the third state, and
wherein the output terminal is maintained in the fourth state for a fixed time period, a voltage equal to the first state being maintained to the output terminal and when the output terminal short circuits, the current flowing between the first power supply and the second power supply is stopped.

2. The load drive circuit according to claim 1,
wherein the first switching element comprises an insulated gate bipolar transistor.

3. The load drive circuit according to claim 2,
wherein a voltage applied to a gate of the insulated gate bipolar transistor is divided by a couple of resistances connected in series.

4. The load drive circuit according to claim 3,
wherein a Zener diode is connected to the couple of resistances.

5. The load drive circuit according to claim 1,
wherein the second power supply is a power supply to supply a ground potential.

6. The load drive circuit according to claim 1,
wherein the first couple of MOS field-effect transistors and the second couple of MOS field-effect transistors are coupled each other to form a level shift circuit.

7. A semiconductor device having a plurality of load drive circuits provided for a single output bit, the load drive circuits integrated on common semiconductor substrates to form a plurality of output bits,
wherein the load drive circuits are to supply two kinds of voltages including a high voltage and a low voltage to a load, and comprises:
a first semiconductor switching element being connected between a first power supply and an output terminal;
a diode being connected to a cathode via the output terminal and to an anode via the first semiconductor switching element;
a second semiconductor switching element being connected between the output terminal and a second power supply being to supply a lower potential than the first power supply;
a first couple of MOS field-effect transistors having a first conductivity type, the first couple of MOS field-effect transistors being to control the first semiconductor switching element; and
a second couple of MOS field-effect transistors having a second conductivity type being opposite to the first conductivity type, the second couple of MOS field-effect transistors being to control the first semiconductor switching element,
wherein the output terminal is maintained to a state by the application of a gate drive signal, being a signal applied to the gate terminal of the second couple of MOS field-effect transistors, the state being a first state, a second state having a lower voltage than the first state, a third state having a higher impedance than the first and second states, and a fourth state having a higher impedance than the first and second states and a lower impedance than the third state, and
wherein the output terminal is maintained in the fourth state for a fixed time period, a voltage equal to the first state being maintained to the output terminal and when the output terminal short circuits, the current flowing between the first power supply and the second power supply is stopped.

8. The semiconductor device according to claim 7,
wherein the first switching element comprises an insulated gate bipolar transistor.

9. The load drive circuit according to claim 8,
wherein a voltage applied to a gate of the insulated gate bipolar transistor is divided by a couple of resistances connected in series.

10. The load drive circuit according to claim 9,
wherein a Zener diode is connected to the couple of resistances.

11. The load drive circuit according to claim 7,
wherein the second power supply is a power supply to supply a ground potential.

12. The load drive circuit according to claim 7,
wherein the first couple of MOS field-effect transistors and the second couple of MOS field-effect transistors are coupled each other to form a level shift circuit.

13. A delay circuit comprising:
a first inverter circuit including a first MOS field-effect transistor having a first conductivity type and inputting an input signal and a second MOS field-effect transistor having a second conductivity type being opposite to the first conductivity type and inputting an input signal, the first MOS field-effect transistor and the second MOS field-effect transistor being connected in complementary pairs between a positive power supply and a ground potential;
a second inverter circuit including a third MOS field-effect transistor having a first conductivity type and inputting an output signal of the first inverter circuit and a fourth MOS field-effect transistor having a second conductivity type, the third MOS field-effect transistor and the fourth MOS field-effect transistor being connected in complementary pairs between a positive power supply and a ground potential; and
a fifth MOS field-effect transistor having a second conductivity type being connected in parallel between the first inverter circuit and the second inverter circuit,
wherein the first MOS field-effect transistor and the fifth MOS field-effect transistor have substantially equivalent thermal characteristics to each other.

14. The delay circuit according to claim 13,
wherein the output of the second inverter circuit is connected to the gate of the fifth MOS field-effect transistor.

15. The delay circuit according to claim 14,
wherein the fifth MOS field-effect transistor comprises a drain being connected to the output of the first inverter circuit and a source being connected to a ground potential.

16. The delay circuit according to claim 13,
wherein the delay circuit compensates fluctuations of its delay time caused by temperature fluctuations in accordance with element-specific fluctuations caused by temperature fluctuations in the first MOS field-effect transistor and element-specific fluctuations caused by temperature fluctuations in the fifth MOS field-effect transistor.

17. The semiconductor device according to claim 7, further comprising a delay circuit comprising:
a first inverter circuit including a first MOS field-effect transistor having a first conductivity type and inputting an input signal and a second MOS field-effect transistor having a second conductivity type being opposite to the first conductivity type and inputting an input signal, the first MOS field-effect transistor and the second MOS field-effect transistor being connected in complementary pairs between a positive power supply and a ground potential;
a second inverter circuit including a third MOS field-effect transistor having a first conductivity type and inputting an output signal of the first inverter circuit and a fourth MOS field-effect transistor having a second conductivity type, the third MOS field-effect transistor and the fourth MOS field-effect transistor being connected in complementary pairs between a positive power supply and a ground potential; and
a fifth MOS field-effect transistor having a second conductivity type being connected in parallel between the first inverter circuit and the second inverter circuit,
wherein the first MOS field-effect transistor and the fifth MOS field-effect transistor have substantially equivalent thermal characteristics to each other.

18. The semiconductor device according to claim 17,
wherein the output of the second inverter circuit is connected to the gate of the fifth MOS field-effect transistor.

19. The semiconductor device according to claim 18,
wherein the fifth MOS field-effect transistor comprises a drain being connected to the output of the first inverter circuit and a source being connected to a ground potential.

20. The semiconductor device according to claim 17,
wherein the delay circuit compensates fluctuations of its delay time caused by temperature in accordance with element-specific fluctuations caused by temperature fluctuations in the first MOS field-effect transistor and element-specific fluctuations caused by temperature fluctuations in the fifth MOS field-effect transistor.
